(19) United States
(12) Patent Application Publication
(10) Pub. No.: US 2019/0277370 A1
(43) Pub. Date: Sep. 12, 2019

(54) TENSIONER

(71) Applicant: TSUBAKIMOTO CHAIN CO., Osaka (JP)

(72) Inventors: Yoshitaka Iwasaki, Osaka-shi (JP); Masanori Watanabe, Osaka-shi (JP)

(73) Assignee: TSUBAKIMOTO CHAIN CO., Osaka (JP)

(21) Appl. No.: 16/294,362

(22) Filed: Mar. 6, 2019

(30) Foreign Application Priority Data
Mar. 12, 2018 (JP) 2018-044425

(51) Int. Cl. F16H 7/08; F16K 17/04

(52) U.S. Cl. CPC F16H 7/08; F16H 2007/0814; F16K 17/04

(57) ABSTRACT

To provide a tensioner that is simply structured and easy to assemble, and that is capable of preventing plunger deformation during press-fitting of a relief valve unit, obviating the need for outside diameter grinding after the assembling, and reducing the thickness of the side walls of the plunger. A relief mechanism, which releases oil inside an oil pressure chamber to the outside of the plunger when the oil pressure in the oil pressure chamber becomes high, has a fixing member that is made of resin, that is located between the outer circumference of the relief valve unit and the inner circumference of the plunger hole, and that fixes the relief valve unit in the plunger hole on the front side thereof.

### BACKGROUND OF THE INVENTION

### 1. Field of the Invention

The present invention relates to a tensioner that applies appropriate tension to a running chain, belt, or the like.

### 2. Description of the Related Art

It has been common practice to use a tensioner in order to maintain correct tension of a chain or the like. For example, a chain guide mechanism has been known, which slidably guides, by means of a tensioner lever, a drive chain such as an endless roller chain passing over respective sprockets of a crankshaft and a cam shaft inside an engine room, and which uses a tensioner to bias the tensioner lever to maintain appropriate tension of the chain or the like.

One known tensioner used in such a chain guide mechanism is a tensioner 510 including, as shown in FIG. 12: a plunger 520 having a plunger hole 522 that is open on a rear side; a housing 530 having a plunger bore 531 that is open on a front side and accommodating the plunger 520; a relief mechanism 550 that releases oil in an oil pressure chamber 511 to the outside of the plunger 520 when oil pressure in the oil pressure chamber 511 becomes high; and a main spring 560 that is accommodated in the oil pressure chamber 511 formed between the plunger 520 and the plunger bore 531, such as to freely expand and contract, and that biases the plunger 520 toward the front side (see, for example, Japanese Patent Application Laid-open No. 2001-12569).

In the tensioner 510 described in Japanese Patent Application Laid-open No. 2001-12569, a pressure passage 524 that communicates with the oil pressure chamber 511, a discharge hole 523 that connects the pressure passage 524 with the outside of the plunger 520, and a spring accommodating space 525 formed on the front side of the pressure passage 524 are formed at the bottom of the plunger 520. The relief mechanism 550 is constituted of a valve member 551 that is slidably fitted in the pressure passage 524, and a relief spring 552 that is set inside the spring accommodating space 525 and that biases the valve member 551 toward the oil pressure chamber 511.

In this tensioner 510, when the oil pressure in the oil pressure chamber 511 becomes high, the valve member 551 moves forward against the biasing force of the relief spring 552 so that the pressure passage 524 communicates with the discharge hole 523 and the oil is released from the discharge hole 523.

One problem with such tensioner 510 is that the plunger 520 has a complex structure, because of which high machining precision is required and assembling is complex.

Another known tensioner is configured so that relief valve components are integrated into a unit and inserted in the plunger, and that the plunger is provided with an external relief hole for discharging released oil to the outside, thereby achieving a simplified structure of a plunger and facilitating assembly (see, WO 2016/109165, for example).

In a tensioner 610 described in WO 2016/109165, as shown in FIG. 13 (or in part of FIG. 1 in WO 2016/109165), a relief valve unit 651 (48) is inserted in a plunger 620 (16) on the front side thereof. An oil leak part 671 provided to a cap member 656 of the relief valve unit 651 (48) is directly connected to an external relief hole 623 (16b) that is opened to the front side of the plunger 620 (16) so that released oil is discharged from the front side to the outside of the plunger 620 (16).

### SUMMARY OF THE INVENTION

When press-fitting the relief valve unit 651 (48) into the plunger 620 (16) and fixing it on the front side thereof in assembling the tensioner 610 described in WO 2016/109165, the inside diameter of the plunger 620 (16) and the outside diameter of the cap member 656 require high machining precision in order to satisfy press-fit standards.

Moreover, in order to allow smooth insertion of the relief valve unit 651 (48) and to allow it to be press-fitted to the distal end inside the plunger 620 (16), the plunger 620 (16) needs to be increased in inside diameter on the rear side of the press-fit part. This means that the inside diameter of the plunger 620 (16) requires two machining steps, which leads to an increased number of machining steps.

Moreover, press-fitting the relief valve unit 651 (48) causes the plunger 620 (16) in the press-fit part to expand radially outward, because of which outside diameter grinding is required after the assembling. This also makes it difficult to reduce the thickness of the side walls of the plunger 620 (16).

The present invention solves these problems and it is an object of the invention to provide a tensioner that is simply structured and easy to assemble, and that is capable of preventing plunger deformation during press-fitting of a relief valve unit, obviating the need for outside diameter grinding after the assembling, and reducing the thickness of the side walls of the plunger.

The present invention solves the problems described above by providing a tensioner including: a plunger having a plunger hole that is open on a rear side; a housing having a plunger bore that is open on a front side and accommodating the plunger; main biasing means that biases the plunger toward the front side; and a relief mechanism that releases oil inside an oil pressure chamber to an outside of the plunger when oil pressure in the oil pressure chamber becomes high. The relief mechanism includes a relief valve unit that is inserted in the plunger hole on a front side thereof, and an external relief hole that connects a relief-side space of the relief valve unit in the plunger hole with the outside of the plunger. The relief mechanism further includes a fixing member that is made of resin, that is located between an outer circumference of the relief valve unit and an inner circumference of the plunger hole, and that fixes the relief valve unit in the plunger hole on the front side thereof.

According to the present invention set forth in claim 1, when the oil pressure in the oil pressure chamber rises, the valve member is moved away from the oil pressure chamber by the rising oil pressure, so that the oil can be released from the oil pressure chamber into the relief-side space through between the valve member and a partitioned part. Moreover, the following effects can be achieved.

According to the present invention set forth in claim 1, the relief mechanism further includes a fixing member that is made of resin, that is located between an outer circumference of the relief valve unit and an inner circumference of the plunger hole, that and fixes the relief valve unit in the plunger hole on the front side thereof. Since the relief valve unit is not press-fitted and only the resin fixing member is press-fitted, the relief valve unit can be readily inserted during assembly. The outer circumference of the relief valve unit and the inner circumference of the plunger hole need not be machined with high precision, and the number of machining steps can be reduced.

Moreover, plunger deformation is prevented, and the plunger can be made thinner in thickness and lighter in weight. A certain shape accuracy of the plunger can be achieved without the need for outside diameter grinding after the assembling.

According to the present invention set forth in claim 2, the fixing member is formed into an annular shape so as to be fitted around the relief valve unit as well as press-fitted into the plunger hole. This not only ensures that the relief valve unit is fixed at the center inside the plunger, but also enables reliable control of oil leakage from the outer circumference of the relief valve unit.

According to the present invention set forth in claim 3, the fixing member includes a holder part that holds the relief valve unit, a spring seat part that receives an end of the main biasing means, and an extension bar that extends into the main biasing means. The volume of the oil pressure chamber is reduced by the extension bar, so that, even when there is no oil in the oil pressure chamber at the start of oil supply, the oil pressure chamber can be quickly filled with oil.

According to the present invention set forth in claim 4, the fixing member includes a relief part that allows oil to flow between the oil pressure chamber and the relief-side space of the relief valve unit. Thus an oil release path in the form of an orifice can be provided in addition to the relief valve.

According to the present invention set forth in claim 5, the relief part is a relief groove formed in a surface that makes contact with the inner circumference of the plunger hole. In this way, an oil release path in the form of an orifice can be provided by only forming a simple-structured groove on the outer face of the fixing member.

According to the present invention set forth in claim 6, the relief valve unit includes a seat member, a valve ball that is accommodated in the seat member, a spring that biases the valve ball, a stopper member that holds the spring and restricts a movement range of the valve ball, and a cap member that is fitted to the seat member and retains the stopper member inside the seat member. The cap member includes an oil leak part for allowing released oil to be discharged to the relief-side space. The oil leak part only needs to be communicated with the space that leads to an external relief hole of the plunger, and need not necessarily be provided at the axial center.

This obviates the need for an oil path that guides the released oil toward the center, and therefore the structure of the stopper member can be simplified, and the relief valve unit becomes simple in structure and easy to assemble. Also, since the flow resistance is small, pressure relief during oil release can be achieved smoothly.

According to the present invention set forth in claim 7, at least part of the relief valve unit is made of a resin material. This increases the degree of freedom in shape, enables a reduction in weight, and further facilitates the assembling of the relief valve unit. The oil path can be designed in an optimal shape, and flow resistance can be made small so that pressure relief during oil release can be achieved smoothly.

### BRIEF DESCRIPTION OF THE DRAWINGS

FIG. 1 is a cross-sectional view of a tensioner according to a first embodiment of the present invention;

FIG. 2 is a cross-sectional view of a plunger of the tensioner according to the first embodiment of the present invention;

FIG. 3 is a perspective view of a fixing member of FIG. 2;

FIG. 4 is a perspective view of the fixing member of FIG. 2 seen from a different angle;

FIG. 5 is a perspective view of a variation example of the fixing member of the tensioner according to the first embodiment of the present invention;

FIG. 6 is a perspective view of the fixing member of FIG. 5 seen from a different angle;

FIG. 7 is a perspective view of another variation example of the fixing member of the tensioner according to the first embodiment of the present invention;

FIG. 8 is a perspective view of the fixing member of FIG. 7 seen from a different angle;

FIG. 9 is a cross-sectional view of a plunger of a tensioner according to a second embodiment of the present invention;

FIG. 10 is a perspective view of a fixing member of FIG. 9;

FIG. 11 is a cross-sectional view of the fixing member of FIG. 9;

FIG. 12 is a cross-sectional view illustrating a conventional tensioner;

FIG. 13 is a cross-sectional view illustrating another conventional tensioner; and

FIG. 14 is an illustrative diagram showing a timing system in which the tensioner is incorporated.

### DESCRIPTION OF THE PREFERRED EMBODIMENTS

A tensioner according to a first embodiment of the present invention will be described below with reference to the drawings.

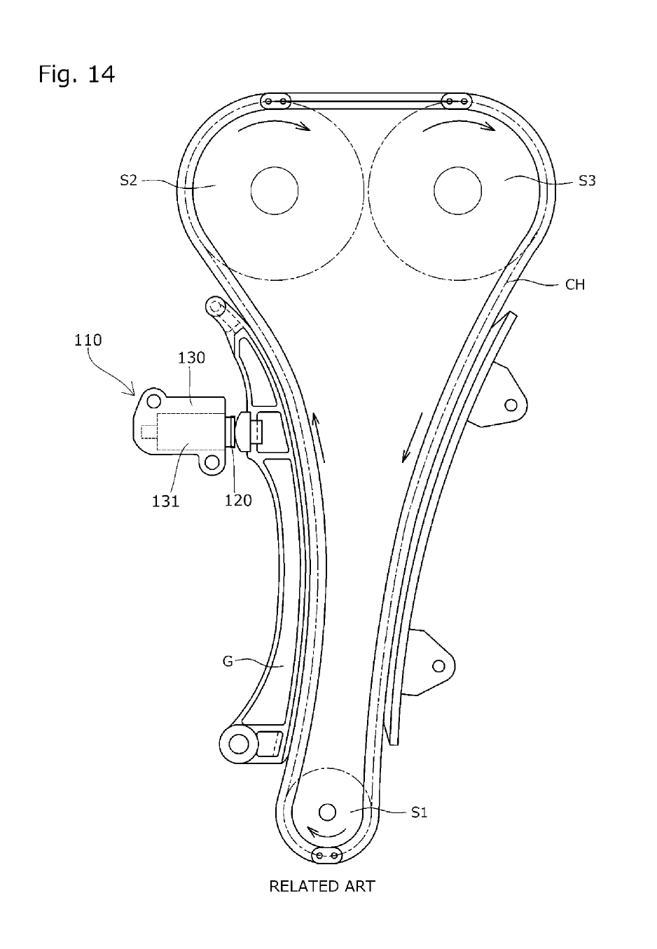

The tensioner 110 is incorporated in a chain drive used in a timing system or the like of a car engine. As shown in FIG. 14, the tensioner is attached to an engine block (not shown) to apply appropriate tension to the slack side of a drive chain CH passing over a plurality of sprockets S1 to S3 via a tensioner lever G to reduce vibration during the drive.

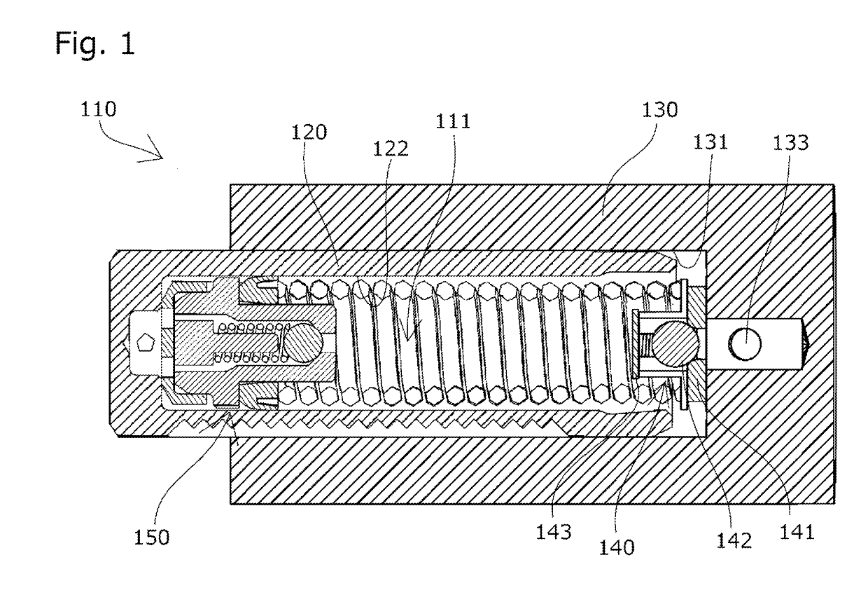

The tensioner 110 includes, as shown in FIG. 1, a plunger 120 having a plunger hole 122 that is open on a rear side, a housing 130 having a plunger bore 131 that is open on a front side for accommodating the plunger 120, a check valve 140 disposed on the bottom side of the housing 130, a relief mechanism 150 that releases oil from the oil pressure chamber 111 to the outside of the plunger 120 when the oil pressure inside the oil pressure chamber 111 becomes high, and a main spring (main biasing means) 160 accommodated inside the oil pressure chamber 111 that is formed between the plunger 120 and the plunger bore 131 such as to freely expand and contract and to bias the plunger 120 toward the front side.

The check valve 140 allows the oil to flow into the oil pressure chamber 111 from the outside through an oil supply hole 133, and stops the oil from flowing out from the oil supply hole 133. The check valve is constituted of a ball seat 141 disposed in tight contact with the bottom of the plunger bore 131, a spherical check ball 142 that can be seated on the ball seat 141 in tight contact therewith, and a retainer 143 arranged on the front side of the check ball 142 to restrict the movement of the check ball 142.

A ball spring that biases the check ball 142 toward the ball seat 141 may be disposed between the check ball 142 and the retainer 143.

The housing 130 is shown schematically; the detailed structure such as a ratchet pawl or the like provided on the outer circumference of the plunger 120 to mate with ratchet teeth is not shown.

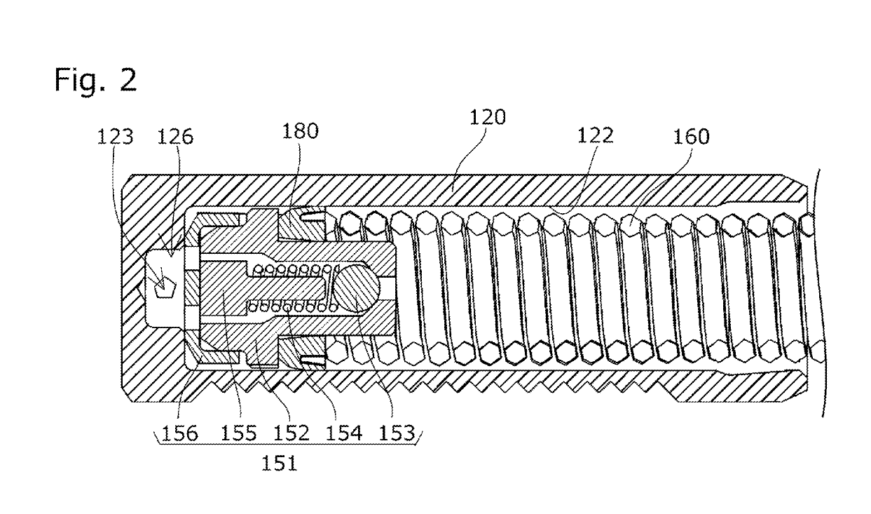

The plunger 120 of the tensioner 110 according to the first embodiment includes a relief mechanism 150, as shown in FIG. 2, constituted of a relief valve unit 151 that is inserted in the plunger hole 122 on the front side thereof, and an external relief hole 123 that communicates a relief-side space 126 of the relief valve unit 151 with the outside of the plunger 120.

The external relief hole 123 opens radially in an outer circumferential surface of the plunger 120.

The relief valve unit 151 includes a seat member 152, a valve ball 153 that is accommodated in the seat member 152, a spring 154 that biases the valve ball 153, a stopper member 155 that holds the spring 154 and restricts the movement range of the valve ball 153, and a cap member 156 that is fitted to the seat member 152 and retains the stopper member 155 inside the seat member 152.

The cap member 156 has openings for the released oil to be discharged to the relief-side space 126.

A fixing member 180 made of resin is disposed between the outer circumference of the relief valve unit 151 and the inner circumference of the plunger hole 122 for fixing the relief valve unit 151 to the front side of the plunger hole 122.

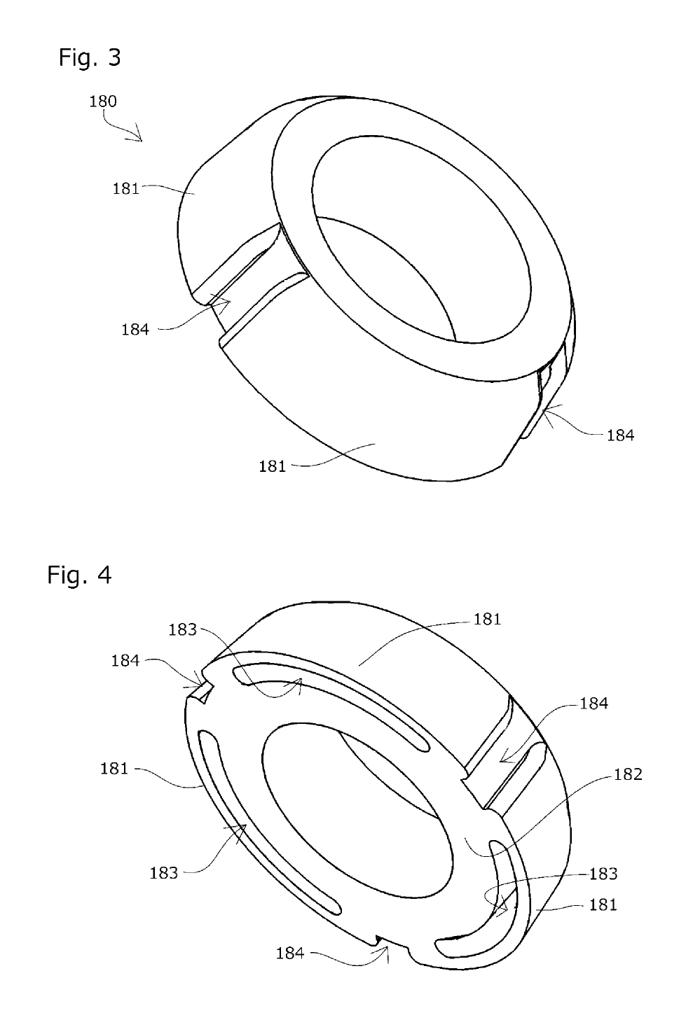

The fixing member 180 is formed into an annular shape as shown in FIG. 3 or FIG. 4, and fitted on the relief valve unit 151. Elastic holes 183 of the fixing member 180 allow its outer close-fit parts 181 to deform during press-fitting, and with these outer close-fit parts 181 making tight contact with the plunger hole 122, the relief valve unit 151 is fixed on the front side of the plunger hole 122.

The rear side of the fixing member 180 is formed such as to serve as a spring seat part 182 for the spring 160 that is the main biasing means after the assembling.

In this embodiment, moreover, a plurality of leak grooves 184 are formed on the outer circumference of the fixing member 180 so as to form leak paths between the fixing member and the inner circumference of the plunger hole 122 for allowing the oil in the oil pressure chamber 111 to be released by the orifice effect.

To assemble the tensioner 110 of this embodiment, the valve ball 153, spring 154, and stopper member 155 are set in the seat member 152, and the cap member 156 is fitted to the seat member 152. Thus these components can be integrated as the relief valve unit 151 and handled together.

For housing the relief valve unit 151 inside the plunger 120, the fixing member 180 is fitted on the relief valve unit 151 before they are inserted, so that the relief valve unit 151 itself is not press-fitted to the inner circumference of the plunger hole 122, but only the outer close-fit parts 181 of the fixing member 180 undergo deformation as they are inserted into the hole as far as to the front side and fixed there.

Thus the relief valve unit 151 can be accommodated inside the plunger 120 with a small force and is unlikely to come off.

Since the fixing member 180 is made of resin and includes the elastic holes 183, the pressure applied to the inner wall of the plunger hole 122 when press-fitting the relief valve unit can be reduced, so that the plunger 120 can be made thinner in thickness and lighter in weight.

During use of the tensioner 110 of this embodiment, when the pressure in the oil pressure chamber 111 exceeds a predetermined level, the valve ball 153 separates from the seat member 152 against the pressing force of the spring 154, thereby allowing the pressure to be relieved to the outside via the space around the stopper member 155 inside the relief valve unit 151, the openings of the cap member 156, the relief-side space 126 in the plunger hole 122, and the external relief hole 123 of the plunger 120.

Moreover, in this embodiment, a plurality of leak grooves 184 are formed on the outer circumference of the fixing member 180. Thus the amount of oil leaked from the outer circumference of the relief valve unit 151 can be controlled by changing the shape of the leak grooves 184 in a pressure range below the level at which the relief valve unit 151 is activated.

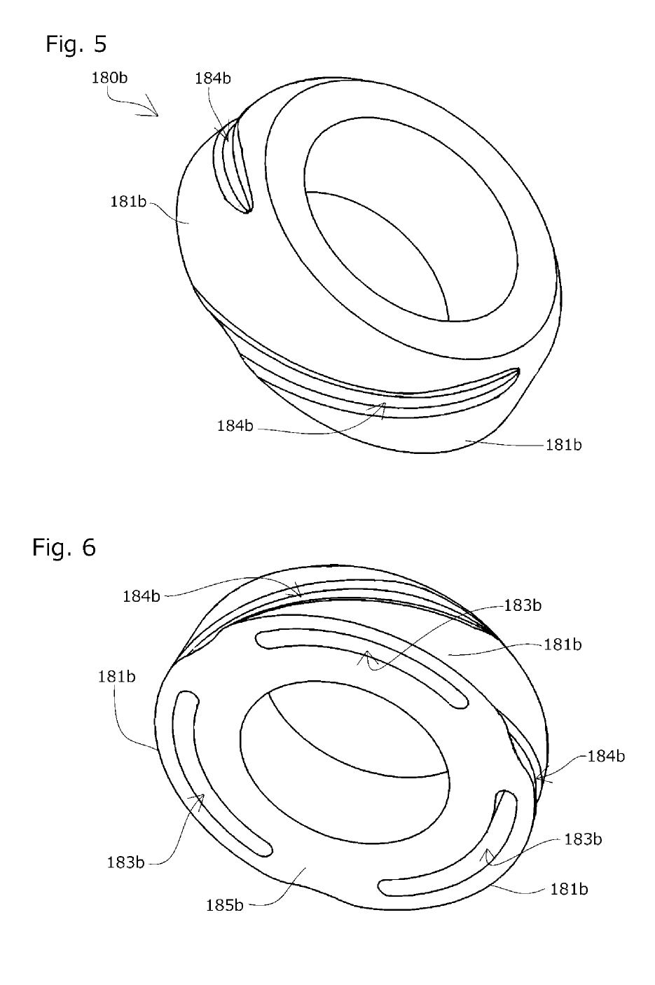

For example, as shown in FIG. 5 or FIG. 6, the fixing member 180b may have helical leak grooves 184b to make the leak paths longer and to reduce the amount of oil leaked from the outer circumference of the relief valve unit 151.

The leak grooves may be omitted to make the amount of oil leaked from the outer circumference of the relief valve unit 151 more or less zero. Conversely, wide leak grooves or more leak grooves may be provided to further increase the amount of oil leaked from the outer circumference of the relief valve unit 151.

The amount of oil leakage can be readily set this way by changing the shape of the resin fixing member 180.

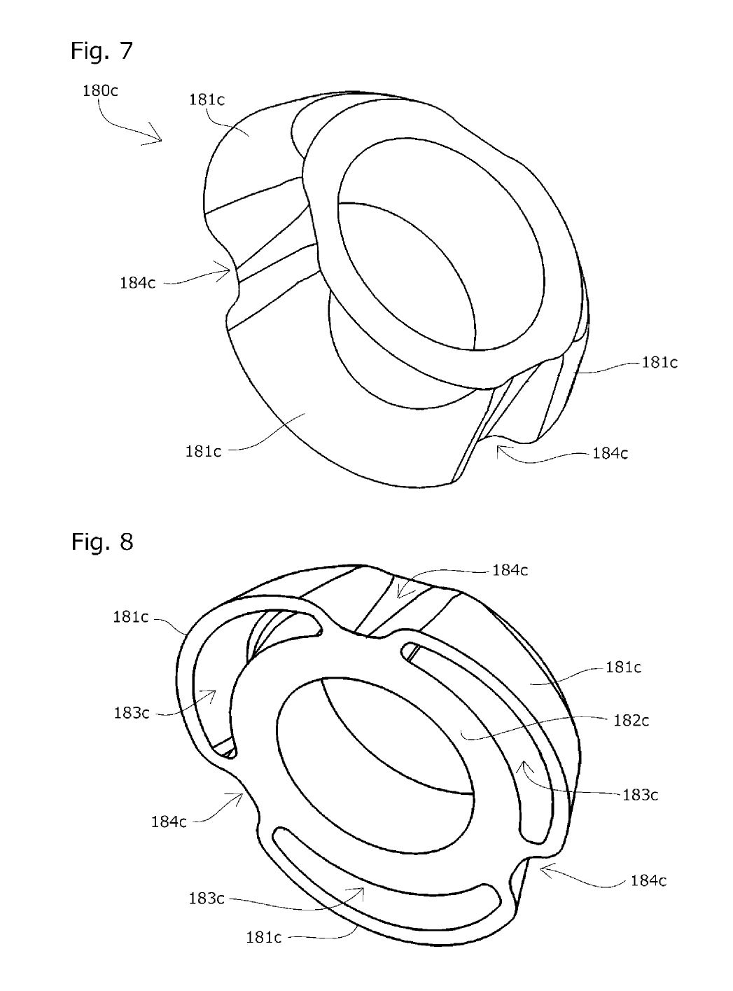

The fixing member 180c may have outer close-fit parts 181c in an outwardly expanded shape as shown in FIG. 7 or FIG. 8 to increase the degree of freedom in size or shape of the elastic holes 183c and to allow the amount of deformation to be adjusted in a wider range.

This in turn will increase the degree of freedom in setting the amount of oil leakage through the leak grooves 184c which will allow more fine adjustment of pressure input/output.

Next, a tensioner according to a second embodiment of the present invention will be described with reference to the drawings.

Description of parts similar to those of the first embodiment will be omitted.

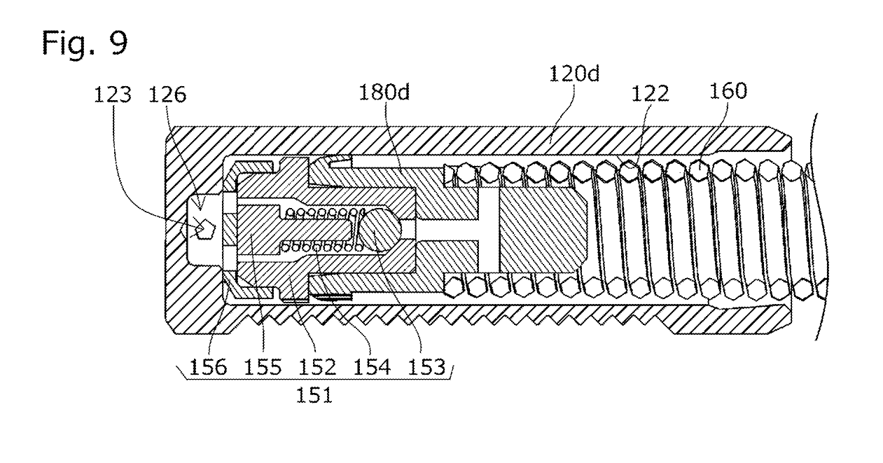

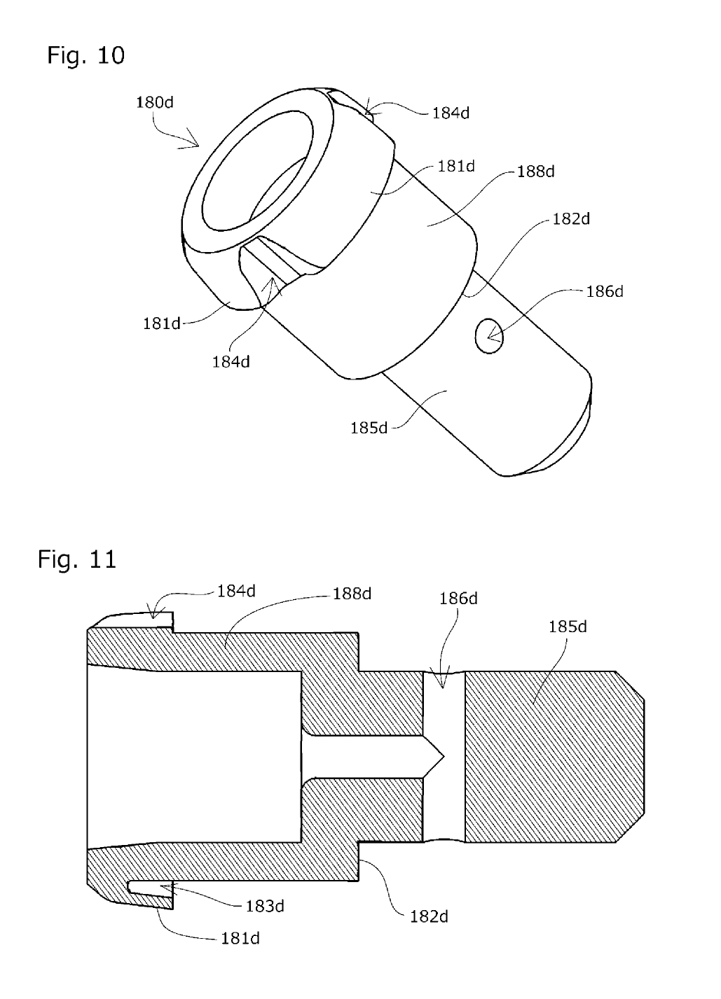

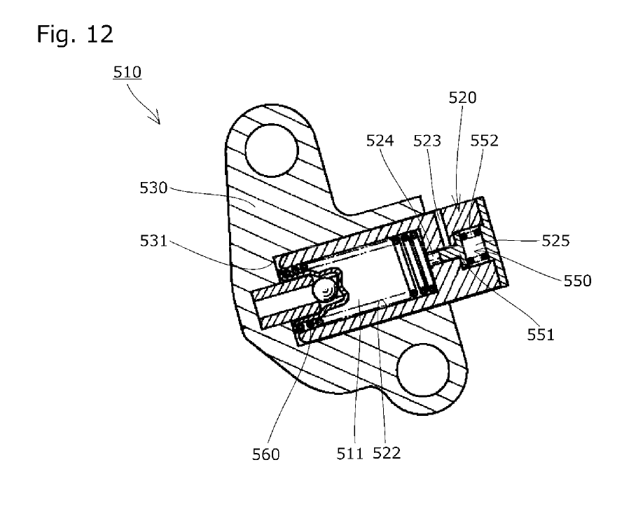

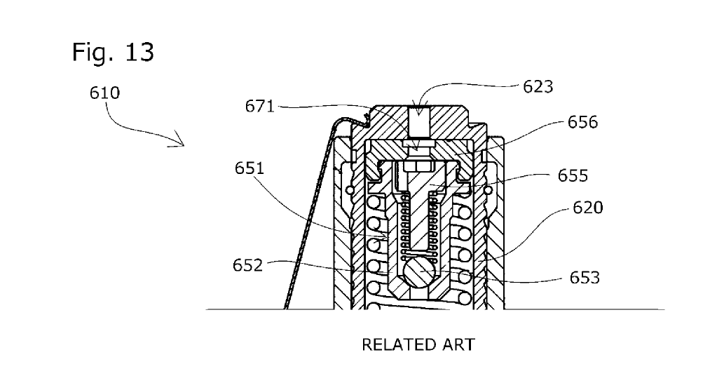

In the plunger 120d of the tensioner according to the second embodiment includes, as shown in FIG. 9, FIG. 10, and

FIG. 11, a resin fixing member 180d includes a holder part 188d that holds the relief valve unit 151, a spring seat part 182d that receives one end of the spring 160 that is the main biasing member, and an extension bar 185d that extends into the spring 160.

The extension bar 185d is provided with an oil passage 186d for guiding oil to the relief valve unit 151 held by the fixing member.

In this embodiment, the volume of the oil pressure chamber is reduced by the extension bar 185d so that, even when there is no oil in the oil pressure chamber at the start of oil supply, the oil pressure chamber can be quickly filled with oil.

The leak grooves 184d provided on the outer close-fit parts 181d can be freely changed in accordance with the designed leakage amount as with the first embodiment.

While embodiments of the present invention have been described above in detail, the present invention is not limited to these embodiments and may be carried out with various design changes without departing from the scope of the present invention set forth in the claims.

For example, while the tensioner 110 was described as a component to be incorporated in a timing system of a car engine in the embodiments above, the purpose of use of the tensioner 110 is not limited to this specific application.

Also, while the tensioner 110 was described as a component that applies tension to a drive chain CH with a tensioner lever G in the embodiments above, the plunger 120 can directly guide the drive chain CH slidably with a distal end thereof to apply tension to the drive chain CH.

The tensioner may not necessarily be applied to a drive system with a drive chain CH but can also be used for similar drive systems that use belts, ropes and the like, and can be applied in a variety of industrial fields where it is required to apply tension to an elongated component.

While the housing 130 accommodating the plunger 120 is described as the component known as a tensioner body that is attached to an engine block or the like in the embodiments described above, the housing 130 is not limited to the specific form described above and may be a component such as a cylindrical sleeve inserted into a body hole formed in the tensioner body.

What is claimed is:

1. A tensioner comprising: a plunger having a plunger hole that is open on a rear side; a housing having a plunger bore that is open on a front side and accommodating the plunger; main biasing means that biases the plunger toward the front side; and a relief mechanism that releases oil inside an oil pressure chamber to an outside of the plunger when oil pressure in the oil pressure chamber becomes high,
the relief mechanism including a relief valve unit that is inserted in the plunger hole on a front side thereof, and an external relief hole that connects a relief-side space of the relief valve unit in the plunger hole with the outside of the plunger,
the relief mechanism further including a fixing member that is made of resin, is located between an outer circumference of the relief valve unit and an inner circumference of the plunger hole, and fixes the relief valve unit in the plunger hole on the front side thereof.

2. The tensioner according to claim 1, wherein the fixing member is formed into an annular shape so as to be fitted around the relief valve unit and press-fitted in the plunger hole.

3. The tensioner according to claim 1, wherein the fixing member includes a holder part that holds the relief valve unit, a spring seat part that receives an end of the main biasing means, and an extension bar that extends into the main biasing means.

4. The tensioner according to claim 2, wherein the fixing member includes a relief part that allows oil to flow between the oil pressure chamber and the relief-side space of the relief valve unit.

5. The tensioner according to claim 4, wherein the relief part is a relief groove formed in a surface that makes contact with the inner circumference of the plunger hole.

6. The tensioner according to claim 1, wherein
the relief valve unit includes a seat member, a valve ball that is accommodated in the seat member, a spring that biases the valve ball, a stopper member that holds the spring and restricts a movement range of the valve ball, and a cap member that is fitted to the seat member and retains the stopper member inside the seat member, and
the cap member includes an oil leak part that allows released oil to be discharged to the relief-side space.

7. The tensioner according to claim 1, wherein at least part of the relief valve unit is made of a resin material.
